(19) United States
(12) Patent Application Publication
(10) Pub. No.: US 2025/0384756 A1
(43) Pub. Date: Dec. 18, 2025

(54) SAFETY COMMUNICATION SYSTEM FOR REMOTE SANDBLASTING OPERATIONS

(71) Applicant: Jon Lambrinos, Campbell, OH (US)

(72) Inventor: Jon Lambrinos, Campbell, OH (US)

(21) Appl. No.: 18/742,273

(22) Filed: Jun. 13, 2024

(51) Int. Cl. G08B 21/18; B24C 9/00; G08B 21/02

(52) U.S. Cl. CPC G08B 21/18; B24C 9/00; G08B 21/02

(57) ABSTRACT

An independent safety warning and integrated notification system for remote operators that require an operator of equipment to be remotely positioned in relation to the blasting pot operator. A notification switch assembly is remotely secured to an existing sandblast hose adjacent the blasting nozzle with an integrated deadman switch allowing the blasting nozzle operator to communicate critical information to the blasting pot operator who controls the blasting supply operation. A combination of warning and notifications including lights and visual display with audible remote alarm assemblies and remotely positioned warning light alarm positioned near the blast pot operator for notification that a prescribed predetermined action has been requested by the blast nozzle operator or an emergency situation exists. A remote single monitoring display panel and notification is provided for use in blast containment areas and a remote monitoring display allows for overseeing the operation via digital communication criteria.

### BACKGROUND OF THE INVENTION

### 1. Technical Field

This invention relates to remote alert and messaging devices, specifically in the sandblasting industry wherein abrasive is discharged from a sandblasting gun or nozzle against a surface to be cleaned. A supply of abrasive is held in a pot and supplied a source of compressed air. Abrasive entrained in an airstream to the discharge nozzle is directed by an operator in a remote location from the sand pot and air supply operator. Given the distance and environment, it is difficult if not impossible for the nozzle operator to communicate with the sand pot and air operator and they are often out of visual range and audio range thereby making direct communication of important information almost impossible which is a production and safety hazard.

### 2. Description of Prior Art

Prior art communication in remote control devices have been developed to assist the nozzle operator in communicating and limited remote control, see for example, applicant's U.S. Pat. No. 6,932,670 directed to a signaling system for sandblasting having a two-position switch with a blast nozzle operator that illuminates the respective light displays from two positions and an audio alarm alerting the pot operator that a prescribed action needs to be taken. Additionally see applicant's U.S. Pat. No. 11,179,827 wherein a warning and alarm system utilizes independent activation switch buttons to secure the blasting supply hose near the blasting nozzle or to an existing dead man switch and an interconnected warning light and audible alarm display remotely positioned near the supply pot and machine operator.

A dead man switch is also available and shown in prior art in which the switch position must be maintained to operate the system and, in some applications, a separate switch is added to signal control from the pot similar to the control notification sequence illustrated in the above referred to applicant's U.S. Pat. No. 6,932,670.

### SUMMARY OF THE INVENTION

An integral multi-functional self-contained communication warning and alarm system for sandblasting and other remote requirement operations. The warning and alarm system utilizes independent remote signaling controller assemblies selectively secured to the blasting supply hose near a discharge blasting nozzle with an integrated dead man switch. An interconnected message and warning display consul located near the sand supply pot and air supply operators. A confined space remote display and activation panel is provided as well as wireless communication access allowing overview of panel operations from off site locations. The system of the invention may be self-powered for ease of installation and set up providing universal adaption to different venue requirements. Multiple remote signaling control units are deployed may have sound, light and indicia representation of actions required as well as two-way call activation. Remotely positioned single signal light beacons are provided with audio alarms for enhance identification for the machine operator. Display control both activation sequence defines action required and confirmation of action taken determined by a preprogrammed circuit controller.

### DESCRIPTION OF THE DRAWINGS

FIG. 1 is a block flow diagram of the safety signaling system of the invention for a sandblasting operation.

FIG. 2 is a block flow diagram showing independent operator activation notice switches.

FIG. 3 is an enlarged top plan view of the remote communication switch assembly.

FIG. 4 is a side elevational view thereof on lines 4-4 of FIG. 3.

FIG. 5 is an enlarged end elevational view on lines 5-5 of FIG. 3.

FIG. 6 is an enlarged top plan view of the communication switch assembly with portions broken away.

FIG. 7 is a front elevational view of the primary signal alarm notification panel module.

FIG. 8 is an enlarged graphic illustration of an advanced optional informational display screen on the panel module.

FIG. 9 is a front elevational view of a remote display and activation panel for confined environments.

### DETAILED DESCRIPTION OF THE INVENTION

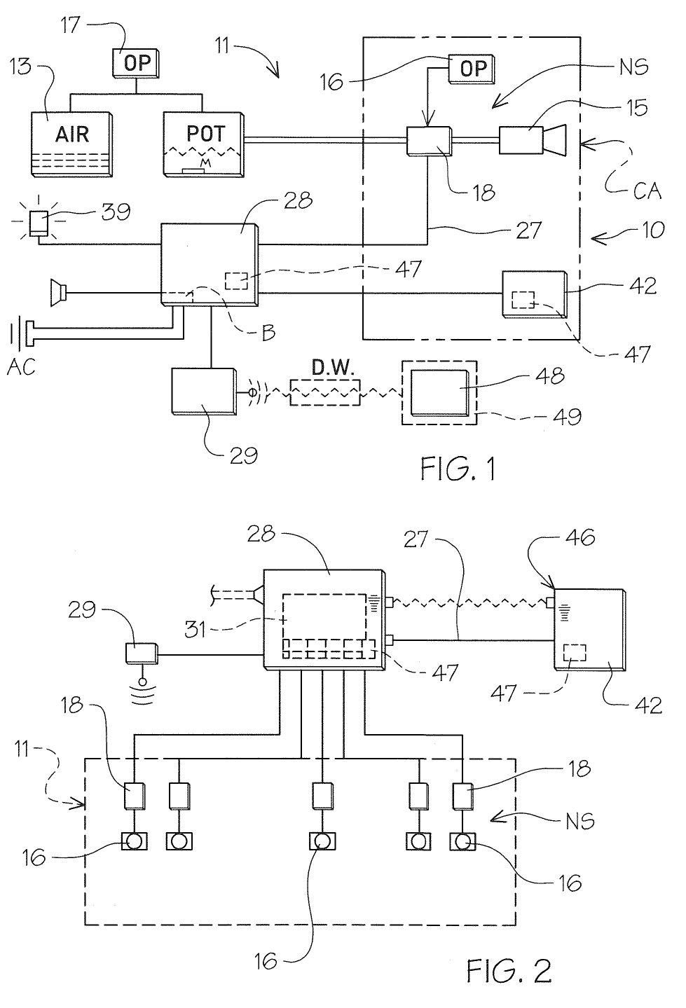

Referring to FIGS. 1 and 2 of the drawings, a safety communication system 10 of the invention can be seen with a sandblast equipment assembly 11 delineated in broken lines there about. The sandblast equipment assembly 11 has a sandblasting abrasive dispensing pot 12 with a supply of compressed air 13 to a blast nozzle supply hose 14 having an outlet blast nozzle 15 thereon controlled by a blast nozzle operator 16. In operation, abrasive blast material M such as sand within the blast pot 12 is mixed with compressed air A and transported through the supply hose 14 under pressure to the outlet blast nozzle 15.

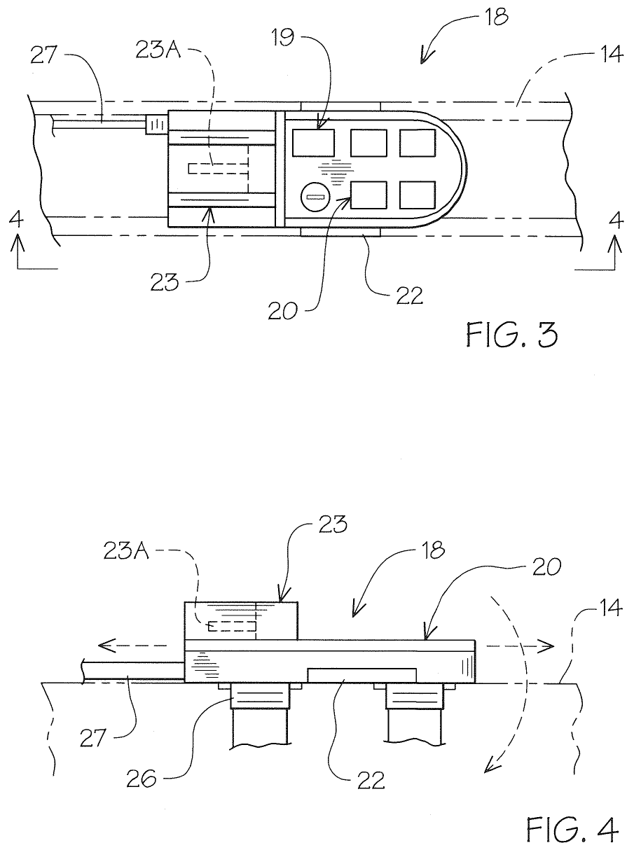

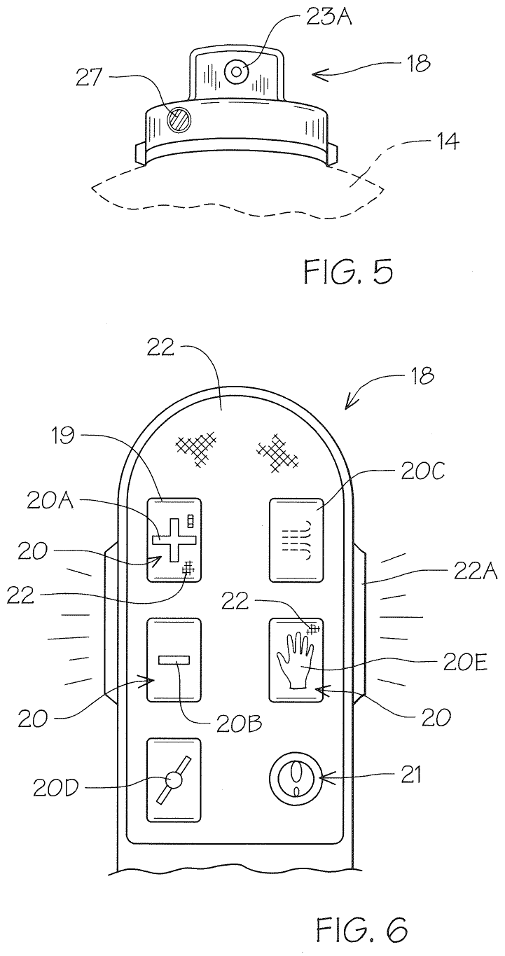

The safety communication and notification system 10 of the invention provides communication between the blast nozzle operator 16 and the sand pot and air supply operator 17. The nozzle operator 16 has a remote notification switch assembly 18, best seen in FIGS. 3-5 of the drawings selectively secured to the supply hose 14 adjacent the blast nozzle 15. The operational notification switch assembly 18 has a plurality of notification buttons 19, each defined with a color light display and function symbol 20 which in this example indicates the following as best seen in FIG. 6 of the drawings. A plus symbol 20A button indicating “more sand”. A minus symbol 20B button indicating “less sand”. An air symbol 20C button indicating “air only” and a choke symbol 20D button indicating “air off momentarily” and a “help” hand illustration 20E button indicating help is needed by the nozzle operator 16 and a red emergency stop button 21.

The notification buttons 19 may be selectively illuminated upon user activation and are covered by an environmentally resistant flexible transparent membrane 22.

The notification switch assembly 18 also has a pair of oppositely disposed side illumination lights 22A that provide location and perimeter illumination if the switch assembly 18 is unplugged by the operator 16. This is an indication to other operators that the switch is non-activated providing operational attention indication.

An industry standard operator's dead man fail safe switch 23 is integrated, in this example, within the notification toggle switch assembly 23A providing a user fail safe configuration as well be well understood by those in the art. The fail-safe switch 23 has the toggle switch 23A positioned in a hooded enclosure allowing for the use of an optional switch retainment insert, not shown, to hold in closed position maintaining air and sand as understood in the art.

The notification switch assembly 18 is mounted on an adjustable hose attachment fitting 26 that will allow for repositioning on the supply hose 14 both longitudinally and annularly there about accommodating a variety of nozzle hose operator orientations as needed.

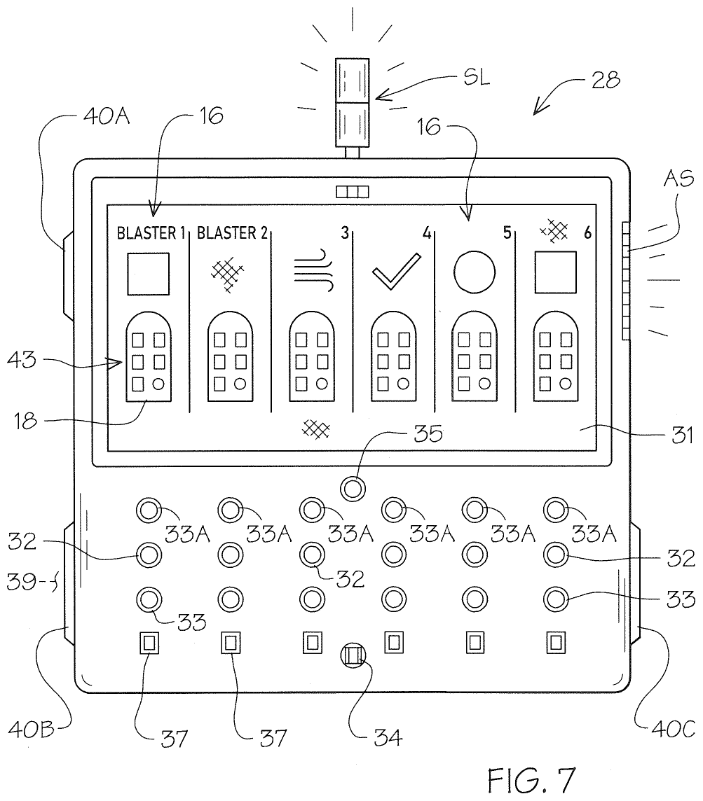

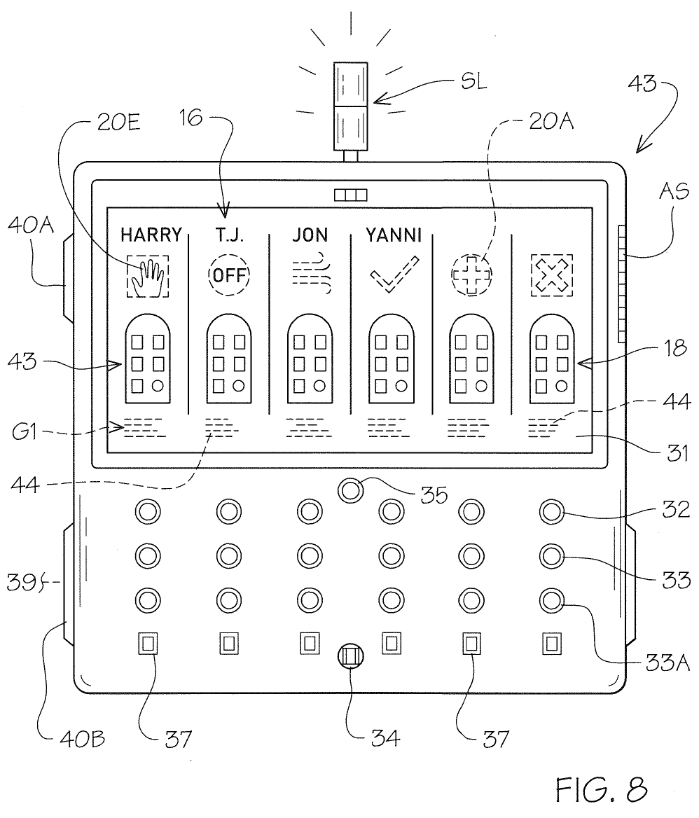

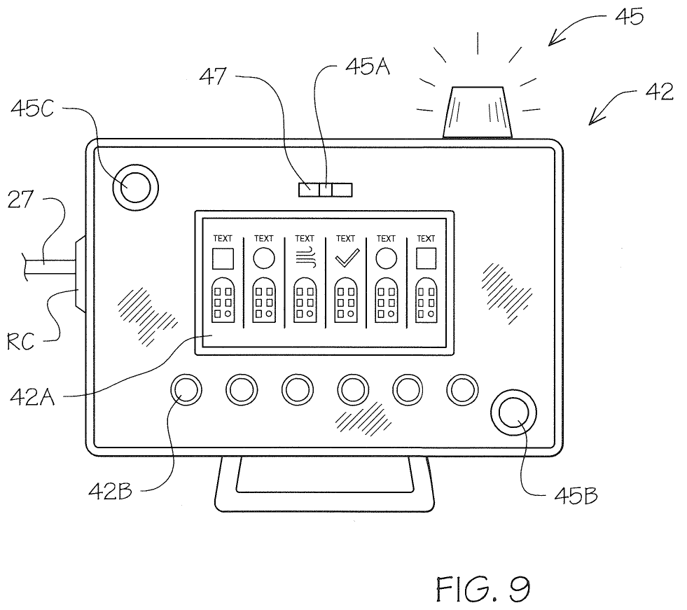

A communication cable 27 extends from the notification switch assembly 18 back to a main “messenger” signal receiver alarm communication panel module 28, best seen in FIG. 7 of the drawings. Alternately, a wireless relay 29 will provide communication from the notification switch assembly 18 to the signal alarm communication panel 28. In this example, the signal communication panel 28 has a square containment housing 30 with a large liquid crystal display (LCD) screen 31 which will display multiple blast operators' notification signal assemblies 18 representation for visual confirmation of the signal activated and graphically display of the requested action corresponding to the hereinbefore disclosed signal buttons 20A-20D.

The LCD display screen 31 will graphically display the notification signal alarm communication assembly 18 of each independent nozzle operator 16 providing identification of each defined user at a nozzle station NS. This comprehensive display and signal activation provides the sand pot and air operator 17 a complete overview of the multiple nozzle station NS of the job in real time.

The notification action signal symbols are illuminated with corresponding colors such as red and green depending on user's use requirements. Each of the multiple nozzle stations NS monitor on the signal panel 28 has a corresponding “call reset” button 32 and call blast button 33 and a confirmation button 33A positioned directly below the respective visual station display. The call blast button 33 and a call reset button 32 provided for communication from the panel 28 to the respective notification signal assembly 18 as will be described in greater detail hereinafter.

There is also a master display panel off and on switch 34 and a vacuum call cancel button 35.

The panel 28 has a plurality of corresponding communication cable input jacks 37 are provided for multiple communication cables 27 from the respective notification signal assemblies 18 in use. Audio alarm AS is provided via an integrated and remote speakers as well as remote visual alarm indicators indicated as multiple signal beacon light alarms 39 which may be positioned around the work site as required.

A pair of “sealed through” side panel signal jacks 40A and 40B provide the signal alarm lights 39 and audio alarms AS as noted and panel power respectively.

A source of power for the main display panel 28 is provided through onboard rechargeable batteries, not shown, or alternately on-site adaptable voltage via universal power receptacle 40B as well as power outlet 40C for a remote signal display confinement panel 42 option as will be disclosed in detail hereinafter. The safety communication system 10 of the invention utilizes custom command and control programming processors that provide signal and multiple source logic to affect its operational criteria, as described. This affords different adaptable display configurations 43 on the same panel such as seen in FIG. 8 of the drawings. In such configuration, the panel display standard view, illustrated in FIG. 7 with the basic multiple blaster station status, as example, indicia blasters 1-5, as hereinbefore described with a visual display representation of each corresponding point of use “nozzle” notification switch assembly 18 of the display by both button representations and an example of selective activation signal buttons graphic representation 20 examples such as B blaster 1, help hand signal 20B B blaster 3 air/purge 20C.

In FIG. 8 of the drawings, an advanced optional display configuration 43 can be selected assigns nozzle blaster stations to an operational name, for example, blaster 3 is now JON. This will additionally provide informational status as to action activity taken such as blow down time, blasting time, more air, less air, more sand in a text display 44, as indicated which is customizable displays for user requirements G1-G4 giving an overview of the performance and status of each of the blaster stations in text display 44.

Referring back to FIGS. 1 and 2 of the drawings, the integrated safety communication system 10 with the sandblast assembly 11 can be seen wherein a complete array of signal displays and warning activation elements are illustrated. The safety communication system 10 acts as a bridge between the sandblasting sand pot and air supply machine operator 17 and the remote located independent operators 16. Each of the independent notification signal assemblies 18 with their communication cable 27 signal information link are monitored by the signal alarm and communication's panel module 28 providing real time notification of actions and alarms requested by the nozzle blast operators 16. Both graphic visual representation and single light activation on the primary panel 28 and auxiliary warning lights and audio sound alarms determine sand pot and air supply operator 17 requested action. Such requests are confirmed and are reset via the reset button 32. By providing action specific buttons on the notification switch assembly 18 and corresponding graphic button activation indications on the primary module panel 28, a clear actuation path is determined. The remote single display panel 42, as seen in FIGS. 1,2, and 9 of the drawings for use in the containment area CA indicated by broken lines in FIG. 1 of the drawings, has a modified graphic screen display 42A with limited multi-functional call/help buttons 42B for each blaster station. A light beacon 45 and master vacuum control on and off and emergency stop buttons 45A, 45B respectively are also provided, multiple call help buttons 46A-F are provided with a hold and cancel function as well as a panel on/off switch 47. Additionally, a multiple roxtex cable input RC for multi-channel signal communication applications. As noted, the remote panel 42 can be positioned within the blast containment area CA environment providing access to a helper, not shown, in the containment area, as needed.

It will be evident that by providing the independent operators 16 with the notification switch assembly 18 that they will be able to communicate directly with the remote sand pot and air operator 17 who controls the blast supply of abrasive and air and overall operation to the blasting nozzle.

This is critical given the blasting environment that prevents normal communication in the reduced visibility and audio environment of the blasting containment area.

An operational example would be the blasting nozzle operator 16 requiring more abrasive sand. The plus symbol button 20A is pressed and held momentarily illuminating it on the single alarm communication assembly 18. This is indicated on the corresponding display screen panel 31 of the panel module 28 under the specific blast operator's display area along with a flashing light 39 and notification alarm sound AS. The sand pot and air machine operator 17 acknowledges same take action and can then reset the system by use of the call reset button 32. If a remote blast nozzle operator 16 needs help, he can press the help button 20E or for an emergency stop button 21. As noted, the containment panel 42 will show all notifications from the blast nozzle operator 16 and corresponding operator 17′s action. This allows for a helper, not shown, using the remote panel 42 to known all ongoing situation and provide assistance, if needed.

It will be evident that the alternate communication venues can be adapted to the safety and communication system 10 of the invention wherein not only actuation symbols 19 and light displays are uses but also voice communication 46 may be introduced by remote microphone. Additionally, the option of a text activation screens 47 on both the notification switch assembly 18 and panel display 31 on the signal alarm notification activation panel modules 28 and 42. This may be supported by a software phone app to initiate text there between.

It should be noted that given the environment in a blasting venue, safety headphones, not shown, are required for the operator 17 and may have communication features via Bluetooth to provide additional notification information to the operator 17 such as notification audio beeps and voice for signaling as hereinbefore disclosed from the blasters.

It will be evident from the above description that a variety of operational conditions and corresponding requirements can easily and effectively allow for communication between the sand pot and air supply operator 17 and the blast nozzle operator 16 as needed. Information of request, initiation of action required and safety protocols can be achieved. Remote overview of the safety communication system 10 can also be monitored by digital web DW base links 48 by an offsite supervisor and management 49 indicated in FIG. 1 of the drawings. It will thus be seen that a new and novel safety and control system for remote operational access has been illustrated and described and it will be apparent to those skilled in the art that various changes and modifications may be made therein without departing from the spirit of the invention. Therefore, I claim:

1. A safety communication system for remote notification and control of industrial equipment for independent operators in isolated locations comprises,
a remote notification switch assembly in communication with a signal receiving communication panel module,
a graphic screen display of said respective notification, switch assemblies on said signal receiving panel module,
signal lights and audio alarms in communication with said signal receiving communication panel module, and a signal notification and cancellation switch,
said remote notification switch assembly comprises, multiple switches, each designating independent actions required,
a remote signal display panel for use in a containment area.

2. The safety communication system set forth in claim 1 wherein said remote notification switch assembly and said signal receiving panel module are interconnected to one another by a communication cable.

3. The safety communication system set forth in claim 1 wherein said remote notification switch assembly and said signal receiving panel module are in communication with one another via wireless transmitter and receiver.

4. The safety communication system set forth in claim 1 wherein said remote notification switch assemblies further comprise, an integral deadman switch and location lights.

5. The safety communication system set forth in claim 1 wherein said signal receiving communication panel further comprises,
a notification switch assembly display screen, call, help and cancel switches, and an emergency stop switch, and a light sound signal alarms.

6. The safety communication system set forth in claim 5 wherein said remote notification switch assembly display further comprises,
graphic representations on individual remote notification switch assemblies and their switch activation status.

7. The safety communication system set forth in claim 1 wherein said signal, light and sound alarms further comprises,
multiple remote position light beacons and speakers activated by said signal receiving communication panel module in response to signals from said remote notification switch assemblies.

8. The safety communication system set forth in claim 1 further comprises, a digital transmission link to offsite telecommunication receivers providing monitoring of safety communication system status.

9. The safety communication system set forth in claim 1 adapted for sandblasting operations comprising, sandblast nozzle, a supply of sand and air under pressure, a supply hose between said sand supply and said nozzle, said remote notification switch assembly adjacently secured to said supply hose adjacent said sandblast nozzle.

10. The safety communication system set forth in claim 9 wherein said remote notification switch assemblies multiple switch designation actions comprises, sand supply increase, sand supply decrease, stopping airflow, help needed and emergency stop.

11. The safety communication system set forth in claim 1 wherein said safety communication system further comprises, text and voice communication actions between said remote notification switch assemblies and said signal receiving communication panel module and said remote signal display panel.

12. The safety communication system set forth in claim 1 wherein said graphic screen display of said respective notifications can be selectively modified to impart additional useful status information.

13. The safety communication system set forth in claim 12 wherein said additional useful user status information may comprise, identification of individual blast operators, a text summary of request and actions taken by the user, operation time for each blast station and voice communication by interlinking displays and switching units.

14. The safety communication system set forth in claim 11 wherein said voice communication action between said remote notification switch assemblies and said signal receiving communication panel module further comprise, safety headphones interconnected via Bluetooth network for receiving notifications from said signal receiving panel and remote notification switch assemblies.
